(19) United States
(12) Patent Application Publication
(10) Pub. No.: US 2026/0129125 A1
(43) Pub. Date: May 7, 2026

(54) Computer Architecture For Intelligent Agent Escalation In A Contact Center

(71) Applicant: Zoom Communications, Inc., San Jose, CA (US)

(72) Inventors: David Robert DeLorimier, Annandale, VA (US); Maikl Adly Abdel-Malek Eskander, Seattle, WA (US); Tetsumasa Yoshikawa, San Francisco, CA (US)

(21) Appl. No.: 18/940,300

(22) Filed: Nov. 7, 2024

(51) Int. Cl. H04M 3/51; G06F 40/35; H04L 51/02

(52) U.S. Cl. CPC H04M 3/5191; G06F 40/35; H04L 51/02; H04M 3/5175; H04M 2203/404

(57) ABSTRACT

A contact center server obtains, during a contact center engagement, a response to a user prompt received from a user device. The response comprises natural language data and a workflow. The contact center server determines, based on activity of the user device associated with the workflow, to connect the user device to an agent device. The agent device is different from a device that generated the natural language data and the workflow. The contact center server generates, using a transformer engine, a summary of the contact center engagement. The summary is a summarization of the natural language data and a representation of user interaction with the workflow. The contact center server transmits, in response to determining to connect the user device to the agent device, the summary for display at the agent device in conjunction with a request for the agent device to connect to the contact center engagement.

### FIELD

This disclosure generally relates to artificial intelligence in contact centers, and, more specifically, to the use of artificial intelligence in adding an agent to a contact center engagement.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a contact center system.

FIG. 5 is a block diagram of an example of a system for intelligent agent escalation.

FIG. 6 is a data flow diagram of an example of intelligent agent escalation.

FIG. 7 is a block diagram of phases of training a generative pretrained transformer (GPT).

FIG. 8 illustrates a first example of a graphical user interface (GUI) for user communication with a contact center server.

FIG. 9 illustrates a second example of a GUI for user communication with a contact center server.

FIG. 10 illustrates a third example of a GUI for user communication with a contact center server.

FIG. 11 illustrates an example of a GUI for inviting an agent to join a contact center engagement.

FIG. 12 is a flowchart of an example of a technique for intelligent agent escalation.

FIG. 13 is a flowchart of an example of a technique for identifying a workflow for revision.

### DETAILED DESCRIPTION

The use of contact centers by or for service providers is becoming increasingly common to address customer support requests over various modalities, including telephony, video, text messaging, chat, and social media. In one example, a contact center may be implemented by an operator of a software platform, such as a unified communications as a service (UCaaS) platform or a contact center as a service (CCaaS) platform, for a customer of the operator. Users of the customer may engage with the contact center to address support requests over one or more communication modalities enabled for use with the contact center by the software platform. In another example, the operator of such a software platform may implement a contact center to address customer support requests related to the software platform itself.

During a contact center engagement, a user of a user device may in some cases initially be connected with a virtual agent engine of a contact center. The user may provide a user prompt stating the reason for the contact center engagement, and the virtual agent engine may provide a natural language response, as well as a workflow (e.g., a set of steps to take or a knowledgebase article to read) for responding to the user prompt. In some cases, the user might desire to continue the contact center engagement with a human agent, or the contact center server may otherwise determine that a human agent would be more effective at addressing the user prompt. In such circumstances, an agent device of the human agent may be added to the contact center engagement and may be provided with the user prompt. In response, the human agent, via their agent device, might generate a similar natural language response or propose the same workflow as the virtual agent engine, frustrating the user and decreasing the goodwill of the user to an organization associated with the contact center. As the foregoing illustrates, techniques for avoiding the repetition of natural language responses and workflows during contact center engagements may be desirable. Furthermore, informing the human agent of what has already transpired in the contact center engagement may be desirable to allow the human agent to most effectively assist the user, for example, by determining where the user experienced difficulties in performing the workflow or interacting with the virtual agent.

Implementations of this disclosure address problems such as those described above by using a transformer engine to summarize a contact center engagement to a human agent when the agent device of the human agent is added to the contact center engagement. During the contact center engagement, a contact center server facilitating the contact center engagement receives a user prompt from a user device. The contact center server generates, using a virtual agent engine, a response to the user prompt. The response includes natural language data (e.g., text or speech) and a workflow (e.g., a knowledgebase article or a set of steps to complete). The contact center server determines that the user device is to be connected to the agent device, for example, in response to a request received from the user device. The contact center server generates, using a transformer engine, a summary of the contact center engagement. The summary includes data representing user interaction with the workflow (e.g., which parts of the workflow were completed or read, or how much time the user spends interacting with or reading the workflow). The contact center server transmits the summary for display at the agent device in conjunction with a request for the agent device to connect to the contact center engagement.

As a result, upon connection to the contact center engagement, the human agent is provisioned with a summary of the contact center engagement and may thus become familiar with what transpired in the contact center engagement so far and what workflows were presented to the user. Furthermore, in some cases, the summary includes a representation of the user's interaction with the virtual agent and a representation of the user's progress through the presented workflows, allowing determination of whether the correct workflows were presented and what difficulties the user had in performing the workflows.

In some examples of the present disclosure, implementations may include or otherwise use one or more artificial intelligence or machine learning (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

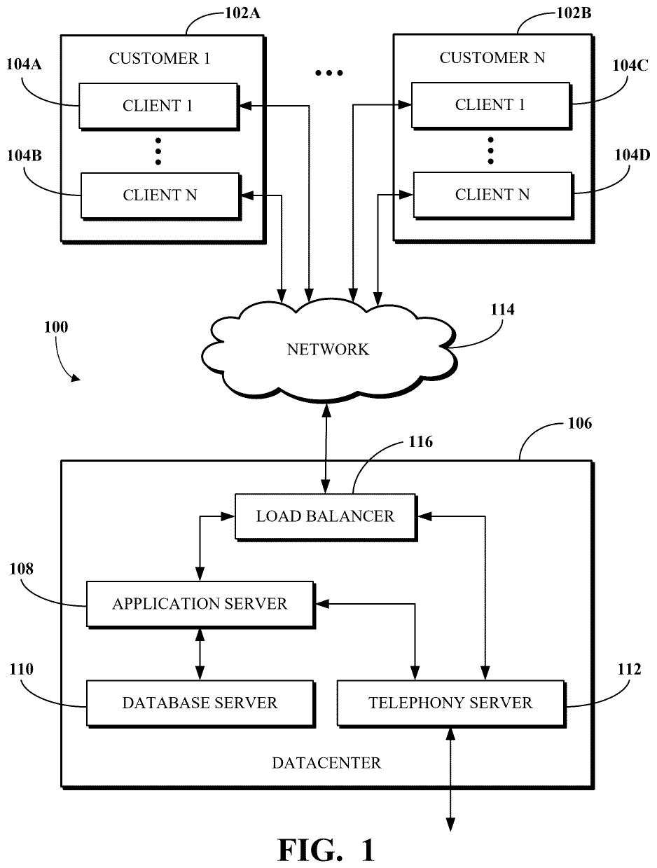

To describe some implementations in greater detail, reference is first made to examples of hardware and software structures used to implement a system for intelligent agent escalation in a contact center. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

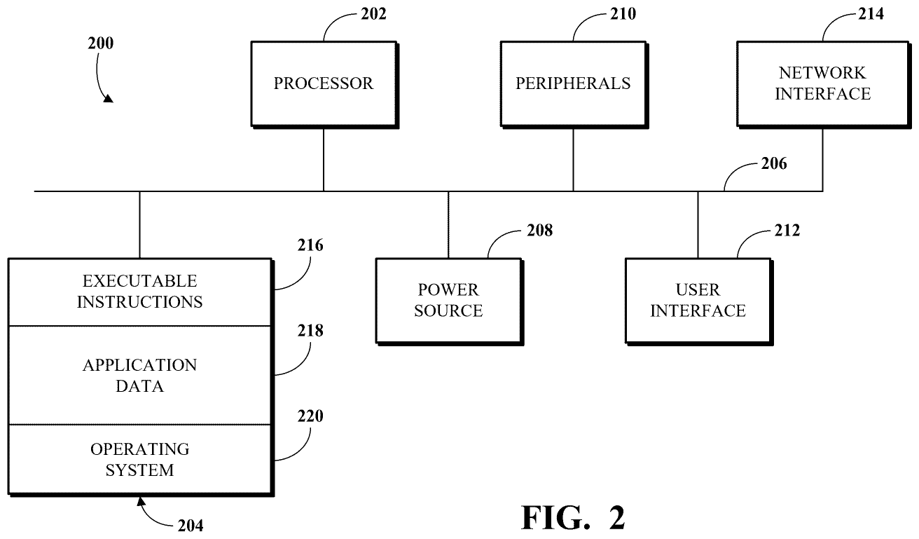

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

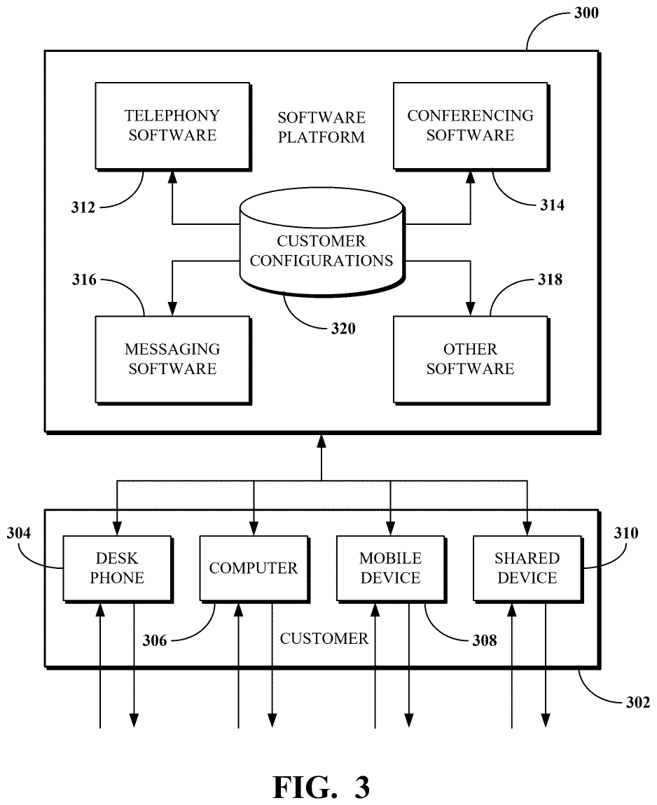

FIG. 3 is a block diagram of an example of a software platform 300 implemented by an electronic computing and communications system, for example, the system 100 shown in FIG. 1. The software platform 300 is a UCaaS platform or CCaaS accessible by clients of a customer of a UCaaS or CCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients - a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for intelligent agent escalation in a contact center.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

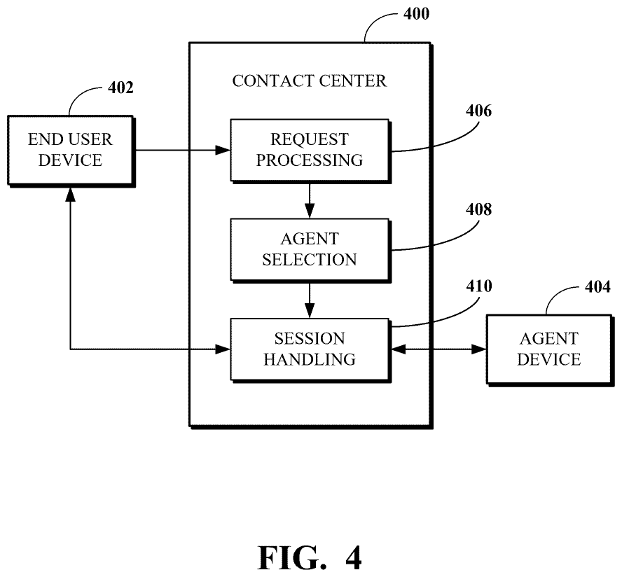

FIG. 4 is a block diagram of an example of a contact center system. A contact center 400, which in some cases may be implemented in connection with a software platform (e.g., the software platform 300 shown in FIG. 3), is accessed by a user device 402 and used to establish a connection between the user device 402 and an agent device 404 over one of multiple modalities available for use with the contact center 400, for example, telephony, video, text messaging, chat, and social media. The contact center 400 is implemented using one or more servers and software running thereon. For example, the contact center 400 may be implemented using one or more of the servers 108 through 112 shown in FIG. 1 and may use communication software such as or similar to the software 312 through 318 shown in FIG. 3. The contact center 400 includes software for facilitating contact center engagements requested by user devices such as the user device 402. As shown, the software includes request processing software 406, agent selection software 408, and session handling software 410.

The request processing software 406 processes a request for a contact center engagement initiated by the user device 402 to determine information associated with the request. The request may include a natural language query or a request entered in another manner (e.g., “press 1 to pay a bill, press 2 to request service”). The information associated with the request generally includes information identifying the purpose of the request and which is usable to direct the request traffic to a contact center agent capable of addressing the request. The information associated with the request may include information obtained from a user of the user device 402 after the request is initiated. For example, for the telephony modality, the request processing software 406 may use an interactive voice response (IVR) menu to prompt the user of the user device to present information associated with the purpose of the request, such as by identifying a category or sub-category of support requested. In another example, for the video modality, the request processing software 406 may use a form or other interactive user interface to prompt a user of the user device 402 to select options which correspond to the purpose of the request. In yet another example, for the chat modality, the request processing software 406 may ask the user of the user device 402 to summarize the purpose of the request (e.g., the natural language query) via text and thereafter process the text entered by the user device 402 using natural language processing and/or other processing.

The session handling software 410 establishes a connection between the user device 402 and the agent device 404, which is the device of the agent selected by the agent selection software 408. The particular manner of the connection and the process for establishing same may be based on the modality used for the contact center engagement requested by the user device 402. The contact center engagement is then facilitated over the established connection. For example, facilitating the contact center engagement over the established connection can include enabling the user of the user device 402 and the selected agent associated with the agent device 404 to engage in a discussion over the subject modality to address the purpose of the request from the user device 402. The facilitation of the contact center engagement over the established connection can use communication software implemented in connection with a software platform, for example, one of the software 312 through 318, or like software.

The user device 402 is a device configured to initiate a request for a contact center engagement which may be obtained and processed using the request processing software 406. In some cases, the user device 402 may be a client device, for example, one of the clients 304 through 310 shown in FIG. 3. For example, the user device 402 may use a client application running thereat to initiate the request for the contact center engagement. In another example, the connection between the user device 402 and the agent device 404 may be established using software available to a client application running at the user device 402. Alternatively, in some cases, the user device 402 may be other than a client device.

The agent device 404 is a device configured for use by a contact center agent. Where the contact center agent is a human, the agent device 404 is a device having a user interface. In some such cases, the agent device 404 may be a client device, for example, one of the clients 304 through 310, or a non-client device. In some such cases, the agent device 404 may be a server which implements software usable by one or more contact center agents to address contact center engagements requested by contact center users. Where the contact center agent is a non-human, the agent device 404 is a device that may or may not have a user interface. For example, in some such cases, the agent device 404 may be a server which implements software of or otherwise usable in connection with the contact center 400.

Although the request processing software 406, the agent selection software 408, and the session handling software 410 are shown as separate software components, in some implementations, some or all of the request processing software 406, the agent selection software 408, and the session handling software 410 may be combined. For example, the contact center 400 may be or include a single software component which performs the functionality of all of the request processing software 406, the agent selection software 408, and the session handling software 410. In some implementations, one or more of the request processing software 406, the agent selection software 408, or the session handling software 410 may be comprised of multiple software components. In some implementations, the contact center 400 may include software components other than the request processing software 406, the agent selection software 408, and the session handling software 410, such as in addition to or in place of one or more of the request processing software 406, the agent selection software 408, and the session handling software 410.

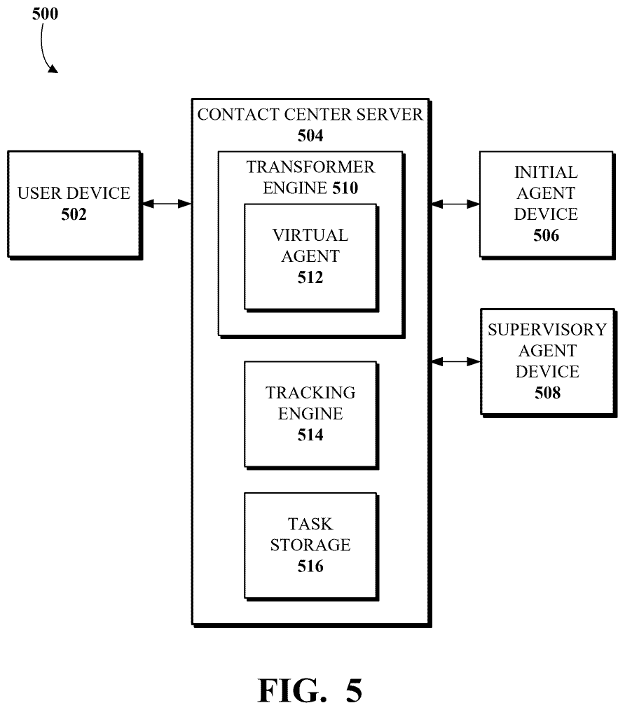

FIG. 5 is a block diagram of an example of a system 500 for intelligent agent escalation. Intelligent agent escalation may include, upon adding an agent (who uses an agent device) to a contact center engagement, informing (via the agent device) the agent of what has already transpired in the contact center engagement to allow for a smooth transition during the addition of the agent. As shown, the system 500 includes a user device 502, a contact center server 504, an initial agent device 506, and a supervisory agent device 508. The user device 502 may be a user device (e.g., the end user device 402) communicating with a contact center (e.g., the contact center 400). The contact center server 504 may be a server (or a set of multiple servers) of the contact center 400 and may perform at least one of the request processing 406, the agent selection 408, or the session handling 410. Each of the initial agent device 506 and the supervisory agent device 508 may correspond to the agent device 404. In some cases, the initial agent device 506 may be operated by an agent who initially communicates with the user of the user device 502, and the supervisory agent device 508 may later be added to the communication. Alternatively, the user may initially communicate with a software agent of the contact center server 504, and the supervisory agent device 508 may later be added to the communication.

As shown, the contact center server 504 includes a transformer engine 510. The transformer engine 510 may be used to generate natural language data based on natural language inputs. For example, the transformer engine 510 includes a virtual agent 512, which may automatically communicate with the user device 502, similar to how a human agent would communicate with the user device 502. In addition, the transformer engine 510 may include software or hardware to summarize or derive intelligence from natural language communications (e.g., between the user device 502 and the initial agent device 506 or the virtual agent 512). The transformer engine 510 may include a large language model (LLM), such as GPT, or other natural language processing technology.

The contact center server 504 also includes a tracking engine 514. The tracking engine 514, upon obtaining appropriate permission from the user device 502, tracks activity of the user device 502 with respect to workflows provided to the user device 502 by at least one of the contact center server 504, the initial agent device 506, or the supervisory agent device 508. In some cases, the tracked activity is provided to the transformer engine 510 and summarized, in images or natural language text, for presentation to a human agent (e.g., via the supervisory agent device 508).

According to some implementations, the user device 502 initiates a contact center engagement by connecting to the contact center server 504 by at least one of a telephone connection, a video conferencing connection, an online interface, or an interface through another network (e.g., a virtual private network for internal support within an organization). The contact center engagement may be handled by the contact center server 504 (e.g., using the virtual agent 510). Alternatively, the user device 502 may be connected to the initial agent device 506 operated by an initial human agent and, with appropriate permissions from the user device 502, the contact center engagement may be recorded by the contact center server 504 and/or made accessible to the transformer engine 510 for real-time or delayed processing as described herein.

Upon connection, the contact center server 504 requests for a user of the user device to provide a user prompt specifying the reason for the contact center engagement. The user prompt may include text or audio in a natural language. Alternatively, the user prompt may be selected using a menu (e.g., an interactive voice response menu) or another user interface element.

The virtual agent 512 or the initial human agent of the initial agent device 506, upon learning the user prompt, generates a response that includes natural language data and a workflow. The workflow may, for example, include or otherwise refer to a knowledgebase article to read or a set of steps to follow to address the user prompt. The contact center server 504 transmits, to the user device 502, the natural language data and a representation of the workflow (e.g., a link to the knowledgebase article, a link to perform the workflow, a description of the workflow, or a representation of a first step of the workflow).

Upon transmission of the response to the user device 502, the tracking engine 514, with appropriate permissions from the user of the user device, tracks activity of the user device 502 associated with the workflow. For example, the tracking engine 514 may track how much (if any) of the workflow was completed, if the user selected a link associated with the workflow, whether the user scrolled through an article associated with the workflow, or where the user stopped or paused scrolling.

Based on the tracked activity of the user device 502 associated with the workflow, the contact center server 504 determines to connect the user device 502 to the supervisory agent device 508. In some cases, the supervisory agent device 508 is associated with a supervisor of the agent of the initial agent device 506. Alternatively, the supervisory agent device 508 may be associated with any agent, not necessarily a supervisor of the agent of the initial agent device 506. For example, the supervisory agent device 508 may be associated with a peer of the agent of the initial agent device 506 who might be better suited to addressing the user prompt. In some cases, the contact center engagement might be initially handled by the virtual agent 512, and the disclosed technology may be implemented without the initial agent device 506.

The determination to connect the user device 502 to the supervisory agent device 508 may be made based on the user failing to perform the workflow or getting stuck in performing the workflow. For example, if the user device 502 is transmitting audio and with sounds indicating user frustration (e.g., grunting sounds), the contact center server 504 may determine to connect the user device 502 to the supervisory agent device 508. Alternatively, if the user device 502 does not open a link associated with the workflow, the contact center server 504 may determine that the workflow is not effective in addressing the user prompt and may connect the user device 502 to the supervisory agent device 508. In some cases, the determination to connect the user device 502 to the supervisory agent device 508 may be made based on a request from the user device 502 or the agent device 508 or based on a signal from the virtual agent 512.

The contact center server 508 generates, using the transformer engine 510, a summary of the contact center engagement. The summary may be generated in real-time during the contact center engagement. Alternatively, the summary may be generated upon making (i.e., based on or in response to) the determination to connect the user device 502 to the supervisory agent device 508. The summary includes a summarization of the natural language data transmitted to the user device 502 and a representation of interaction of the user device 502 with the workflow. The contact center server 508 transmits, in response to determining to connect the user device 502 to the supervisory agent device 508, the summary for display at the supervisory agent device 508 in conjunction with a request for the supervisory agent device 508 to connect to the contact center engagement. This allows the agent using the supervisory agent device 508 to learn what has thus far transpired in the contact center engagement upon and since connecting to the contact center engagement. As a result, the agent of the supervisory agent device 508 may assist the user based on the information that the user has already provided and the interaction the user already completed with the contact center and the workflow.

As shown, the contact center server 504 includes a task storage 516. The task storage 516 may be implemented using one or more data structures, such as at least one of a list, an array, a matrix, a text file, or another data structure. In some cases, when the virtual agent 512 escalates the contact center engagement to the human agent at the supervisory agent device 508, it is possible that human agents are not available at that time. The contact engagement could terminate to an inanimate object such as an inbox (e.g. voicemail, messagemail, videomail) or a work item (e.g. a task or ticket), and a representation of the data transmitted to the inbox or the work item is stored in the task storage 516. A human agent (e.g., operating the supervisory agent device 508 or another device) would later be assigned to handle and process all or a portion of the tasks stored in the task storage, and a part of this may include contacting the user of the user device 502 again at a later time after the contact center engagement is terminated. It should be noted that the transformed summary/data persist in the task storage 516 so that the human agent still has access to this information to know how best to proceed to resolve the issues raised during the engagement. The engagement is eventually processed by a human agent, but it might not be transferred in real-time from the virtual agent 512 to the human agent of the supervisory agent device 508, as described in conjunction with some implementations.

In some implementations, the task storage 516 may be further configured to prioritize or categorize tasks based on the urgency or nature of the contact center engagement. For example, the task storage 516 may apply a set of predefined rules or use machine learning techniques to analyze the content of the contact center engagement and assign a priority level to each task or ticket. This prioritization allows human agents to handle high-priority tasks more promptly, ensuring that critical issues are addressed in a timely manner. Additionally, in cases where multiple human agents are available, the system may distribute tasks among agents based on their availability, expertise, or workload, thus optimizing the efficiency of task resolution. Furthermore, the task storage 516 may retain metadata associated with the engagement, such as timestamps, the identity of the virtual agent 512 involved, and any previous interactions with the user of the user device 502. This metadata can assist human agents in understanding the context of the contact center engagements and make informed decisions when resuming contact with the user, thereby enhancing the overall effectiveness and quality of the customer service experience.

Some implementations of the system 500 include tracking user activity or applying artificial intelligence to user-provided data (e.g., the user prompt or account information of a user account associated with the user prompt). It should be noted that the user is informed of the tracking of the user activity and/or of the application of artificial intelligence to the user-provided data. The informing of the user may be done via email, audio or text presented during the contact center engagement, or persistent on-screen notifications during the contact center engagement. The user is asked to provide affirmative consent prior to tracking the user activity or applying artificial intelligence to the user-provided data, and the user may withdraw their consent at any time. If the user withdraws their consent, their communication with the contact center might be handled in other ways (e.g., by human agents who do not track the user activity or use artificial intelligence to assist with their work).

As used herein, the phrase “natural language” may include, among other things, a language that has developed and evolved naturally for spoken or written communication by humans. Examples of natural languages may include, but are not limited to, English, Spanish, French, and Japanese, as well as informal or hybrid versions of such languages, such as Creole languages or Spanglish.

As used herein, the phrase “real-time” may include, among other things, an operation being performed without any intentional delay. There may still be delay (e.g., of 0.1 seconds, 1 second, 10 seconds, or one hour), for example, due to factors which may include at least one of processor latency, network latency, or memory access latency.

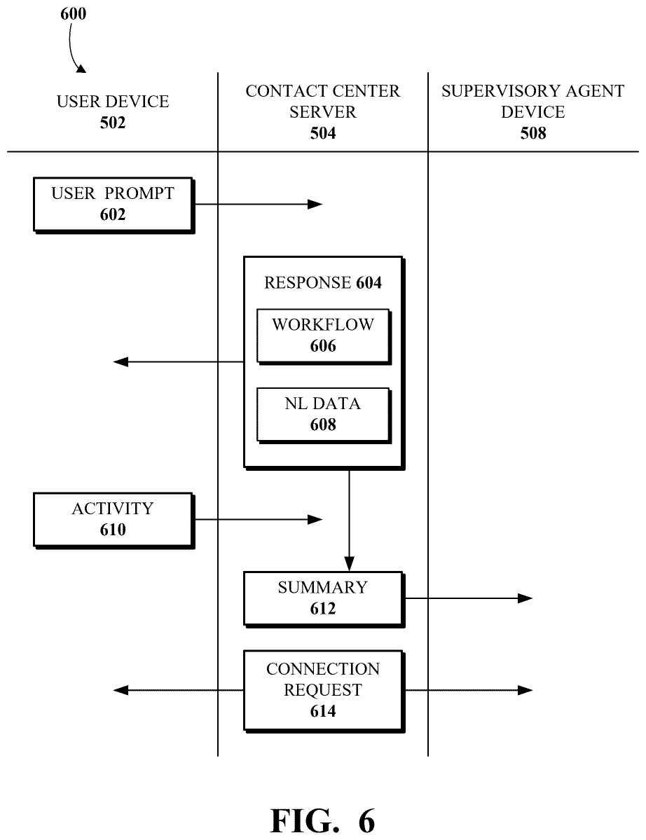

FIG. 6 is a data flow diagram of an example of intelligent agent escalation 600. Intelligent agent escalation may include escalating a contact center engagement to a new agent or a supervisory agent with the assistance of artificial intelligence technology. As illustrated, the intelligent agent escalation 600 is performed using the user device 502, the contact center server 504, and the supervisory agent device 508.

As shown, during a contact center engagement, the user device 502 transmits a user prompt 602 to a contact center server 504. The contact center server 504, using a virtual agent 512 of the contact center server 504 or the initial agent device 506, obtains a response 604 to the user prompt. The response includes a workflow 606 and natural language (NL) data 608. The workflow 606 may be a series of steps for the user of the user device 502 to perform or an article explaining how to address the user prompt 602. The natural language data 608 may include text or audio in a natural language (e.g., the natural language of the user prompt 602). The response 604 is transmitted to the user device 502 for output to a user of the user device 502.

After transmitting the response 504, the contact center server 504 tracks activity 610 of the user device 502, with appropriate permissions from the user of the user device 502. The tracked activity 610 may be limited to activity performed with respect to the contact center engagement (e.g., text, audio, or video data transmitted to the contact center engagement or whether the user select links provided via the contact center engagement).

The contact center server 504 generates a summary 612 of the contact center engagement. The summary includes a summarization of the response 604. In some cases, the summary 612 may also include data representing at least one of the user prompt 602 or the activity 610. As a result, a person (or AI engine) reviewing the summary may learn the user prompt 602, the response 604 that was provided, and the activity 610 of the user device 502 with respect to the response 604. The summary 612 may be generated by the transformer engine 510 of the contact center server 504 and may include at least one of natural language text or imagery. In some cases, the summary 612 has a specified format based on a specification stored in a memory subsystem accessible to the transformer engine 510.

The contact center server 504 determines, based on the activity 610, that the user is not performing the workflow 606 or that the workflow 606 is not effective in addressing the user prompt 602. For example, the activity 610 might include a representation of the user stating that they cannot perform the workflow or that the workflow is not effective. Alternatively, the activity 610 might indicate that the user did not select a link associated with the workflow 606 within a threshold time period (e.g., two minutes or five minutes) of receiving the response 604 including the workflow 606.

As a result of determining that the user is not performing the workflow 606, the contact center server 504 transmits a connection request 614 for connecting the supervisory agent device 508 to the user device 502 in the contact center engagement 604. The connection request 614 is transmitted to the supervisory agent device 508 in conjunction with the summary 612. For example, the summary 612 may be presented on a display of the supervisory agent device 508 in conjunction with user interface icons to accept or reject the connection request 614. After the agent of the supervisory agent device 508 accepts the connection request 614, the summary may remain presented on the display, allowing the agent to refer back to the summary 612 and/or to continue studying the summary 612 while they are participating in the contact center engagement.

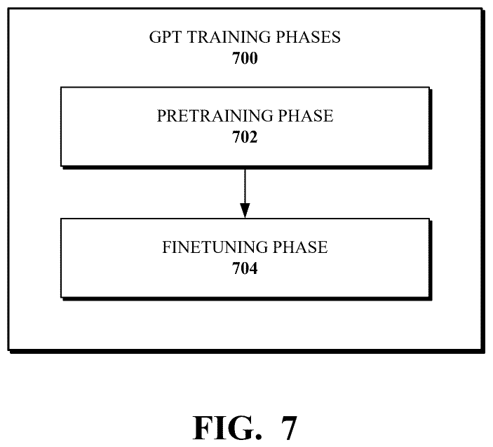

FIG. 7 is a block diagram of GPT training phases 700. The GPT training phases 700 may be phases of training a GPT of the transformer engine 510. As shown, the GPT training phases 700 include a pretraining phase 702 and a finetuning phase 704.

In the pretraining phase 702, the GPT is trained on the natural language data, which may include various publicly available (e.g., from the Internet) text data or audio/video data that is converted into text using speech-to-text technology. The publicly available text data may include text that is distinct from contact center engagement transcripts. For example, the various publicly available text data may include at least one of newspaper articles, blog posts, publicly available social media posts, or encyclopedia articles. The text is used to create a language model that learns to predict the next word in a sentence given the context of the previous words. The transformer architecture, specifically the self-attention mechanism, may be used to capture dependencies between words and create a representation of the text.

During the pretraining phase 702, the GPT learns to generalize the patterns it observes in the training data. Specifically, the GPT learns grammar, facts, reasoning abilities, and some level of world knowledge. The pretraining phase allows the GPT to acquire a broad understanding of the natural languages in which the GPT is trained. The GPT may be trained to operate in multiple natural languages. For example, the GPT may be operated in English for English language data, in Spanish for Spanish language data, and/or in Japanese for Japanese language data.

The pretraining phase 702 may be performed using supervised learning or unsupervised learning. In supervised learning, the GPT is fed a dataset of text where the desired output is already known. This might involve predicting the next word in a sentence or classifying the sentiment of a passage. The GPT learns by adjusting its parameters to minimize the difference between its predictions and the correct answers. On the other hand, unsupervised learning involves training on a corpus of text without explicit labels or desired outputs. The GPT might be tasked with predicting masked words, generating coherent text, or learning the underlying structure and patterns of language. This approach allows the GPT to discover knowledge independently and develop a deeper understanding of language through exposure to diverse data.

During the finetuning phase 704, after the pretraining phase 702, the GPT is further finetuned on specific tasks (e.g., performing the functions of the virtual agent 512 or summarizing a contact center engagement) using labeled examples. The labeled examples may include manually generated (e.g., by employees of a business responsible for training the GPT) fictitious contact center engagements, including examples of summaries and examples of virtual agent responses. As a result, the finetuning phase 704 might not use any private data to train the GPT. The finetuning phase 704 makes the GPT useful for specific applications, such as summarizing a contact center engagement or serving as the virtual agent 512. The finetuning phase 704 involves training the GPT on a narrower dataset that may be generated with the help of human reviewers.

The finetuning phase 704 includes providing prompts or instructions to the GPT and receiving responses from the GPT. For example, a human reviewer may generate a user prompt and instruct the GPT to identify a workflow, from a set of workflows in a data repository, for responding to the user prompt, as well as a natural language response to the user prompt notifying the user of the workflow. The human reviewer then notifies the GPT whether the GPT correctly identified the workflow and generated a relevant natural language response, so that the GPT may be further trained based on its correct identification or incorrect identification and based on the review of the natural language response. The GPT uses reinforcement learning to attempt to improve the accuracy of its generated user prompt-workflow matches and its generated natural language responses.

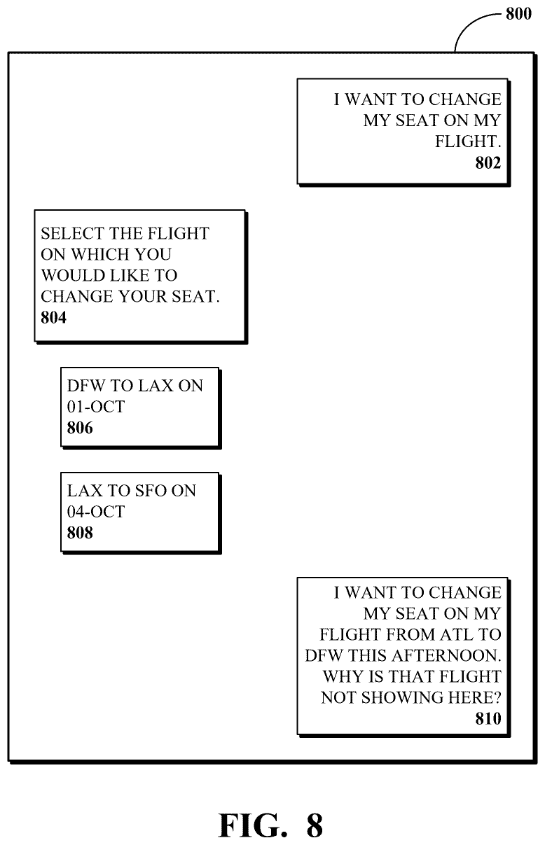

FIG. 8 illustrates a first example of a GUI 800 for user communication with a contact center server (e.g., the contact center server 504). The GUI 800 may be presented at a user device (e.g., the user device 502) connected to the contact center server. At block 802, upon connecting to the contact center server of an airline via an instant messaging service, the user types the prompt, “I want to change my seat on my flight.” This prompt may correspond to the user prompt 602. At block 804, the contact center server (e.g., via a virtual agent, such as the virtual agent 512) generates the response, “Select the flight on which you would like to change your seat.” The contact center server offers two flight options at block 806 and block 808. The two flight options may correspond to an account with the airline associated with the user device and may correspond to the initiation of a workflow for changing the seat on a flight. At block 810, the user indicates that they want to change their seat on a flight scheduled for this afternoon that is different from the options presented in the workflow. Based on this response, the virtual agent may determine that the proposed workflow is not effective for the user (e.g., because the proposed workflow does not allow for seat changes on flights scheduled for the same day as when the workflow is accessed) and may request the assistance of a human agent via an agent device (e.g., the supervisory agent device 508). Upon receiving the response at block 810, the virtual agent might cause the agent device to be added to the contact center engagement, and might transmit the summary of the engagement to the agent device, in order to allow the agent of the agent device to quickly learn what transpired in the contact center engagement so far. This would allow the agent to assist with a same-day seat change, without presenting the previously presented workflow for a second time.

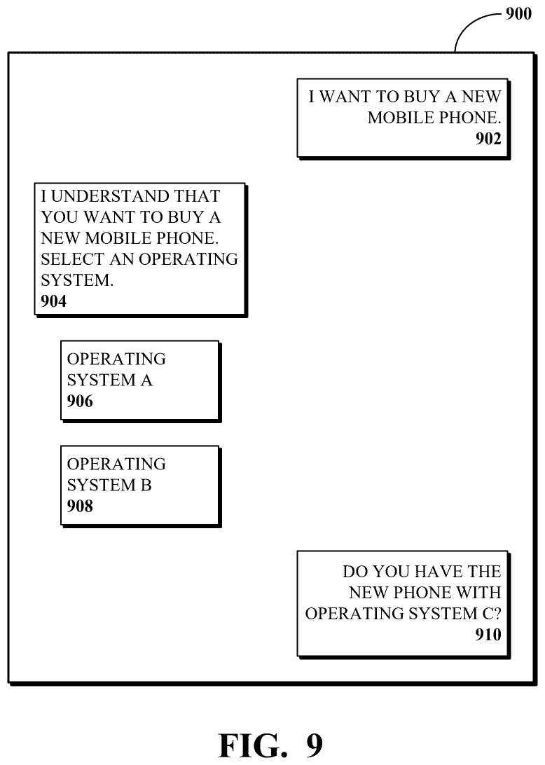

FIG. 9 illustrates a second example of a GUI 900 for user communication with a contact center server (e.g., the contact center server 504). The GUI 900 may be presented at a user device (e.g., the user device 502) connected to the contact center server. At block 902, upon connecting to the contact center server of a mobile phone company via an instant messaging service, the user types the prompt, “I want to buy a new mobile phone.” This prompt may correspond to the user prompt 602. At block 904, the contact center server (e.g., by operation of a virtual agent of the contact center server) generates the response. “I understand that you want to buy a new mobile phone. Select an operating system.” The contact center server offers two operating system options at block 906 and block 908. The two operating system options may correspond to the initiation of a workflow for purchasing a new mobile phone. At block 910, the user indicates that they want a new phone with an operating system that is different from the two options presented at block 906 and block 908. Based on this response of block 910, the virtual agent might determine that the workflow is inappropriate (as the operating system requested by the user is not one of the options). The virtual agent may determine to connect the user device to an agent device (e.g., the supervisory agent device 508) operated by a human agent, in order to have the human agent confirm availability of mobile phones matching the user's specification. Upon receiving the response at block 910, the virtual agent might cause the agent device to be added to the contact center engagement, and might transmit the summary of the engagement to the agent device, in order to allow the agent of the agent device to quickly learn what transpired in the contact center engagement so far. This would allow the agent to immediately determine whether mobile phones with the user's requested operating system are available, and to advise the user accordingly, rather than asking the user if they want one of the two other operating systems.

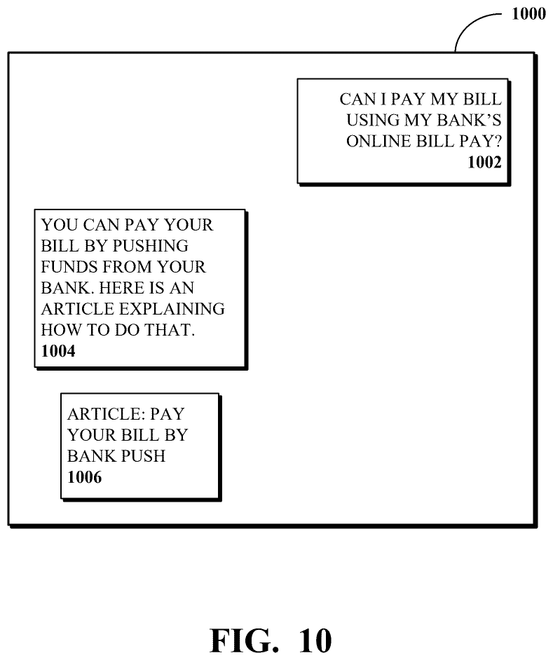

FIG. 10 illustrates a third example of a GUI 1000 for user communication with a contact center server (e.g., the contact center server 506). The GUI 1000 may be presented at a user device (e.g., the user device 502) connected to the contact center server. At block 1002, upon connecting to the contact center server via an instant messaging service, the user types the prompt, “Can I pay my bill using my bank's online bill pay?” This prompt may correspond to the user prompt 602. At block 1004, a virtual agent of the contact center server generates the response, “You can pay your bill by pushing funds from your bank. Here is an article explaining how to do that. The response is coupled with a link to the article, which is provided by the contact center server at block 1006. The article may correspond to the initiation of a workflow for helping the user pay their bill via online banking. In the GUI 1000, the user does not take any action with respect to the article during a threshold time period, for example, two or three minutes. This may occur, for example, because the user is confused by the technical jargon (e.g., “bank push”) in the title of the article or in the response of block 1004. Based on the user not taking any action, the user device may be connected to a human-operated agent device (e.g., the supervisory agent device 508) by the contact center. The agent of the agent device may then assist the user, for example, by explaining the content of the article in a way that the user can understand. The agent might then rewrite the article of block 1006. Alternatively, the article may be automatically rewritten (e.g., by the transformer engine 510) or a new article may be generated based on a determination that the article is not useful for addressing the user prompt of block 1002 and similar user prompts.

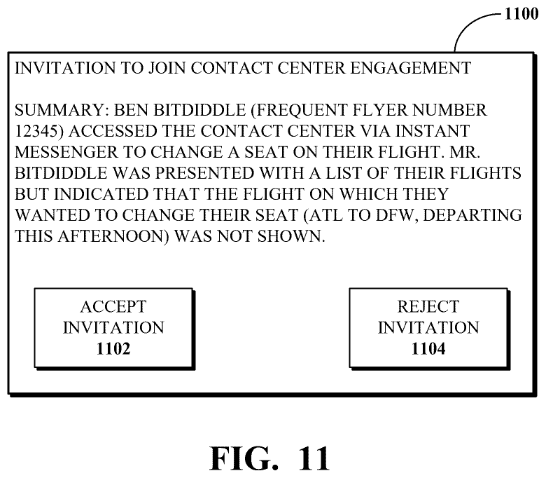

FIG. 11 illustrates an example of a GUI 1100 for inviting an agent to join a contact center engagement. The GUI at 1100 may be presented at an agent device, such as the agent device 404 or the supervisory agent device 508. As illustrated, the GUI 1100 may be presented during the example contact center engagement described in FIG. 8. As shown, the GUI 1100 includes a text summary of the contact center engagement, a button 1102 to accept the invitation and a button 1104 to reject the invitation. The summary identifies the user of the user device (e.g., by name and by frequent flyer number) accessing the contact center and describes, in detail, what transpired in the contact center engagement so far. Specifically, the description states that the user is trying to change their seat on a flight, and that the flight on which they wanted to change their seat, which is departing this afternoon, was not shown in the list of flights which was presented in response to their prompt. Using the information presented in the summary, the agent is unlikely to present the workflow that was presented previously for a second time. Instead, the agent might attempt to locate the records associated with this afternoon's flight to determine whether a seat change is available. As a result, the agent might be more effective in responding to the user's prompt, improving the user experience and saving the time of both the user and the agent.

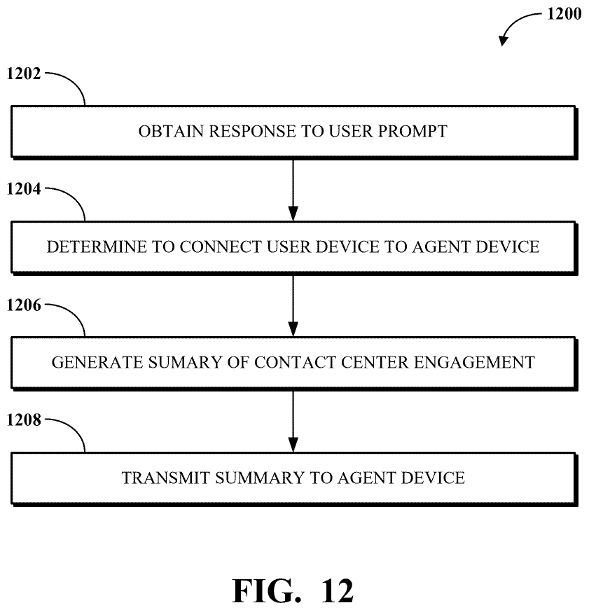

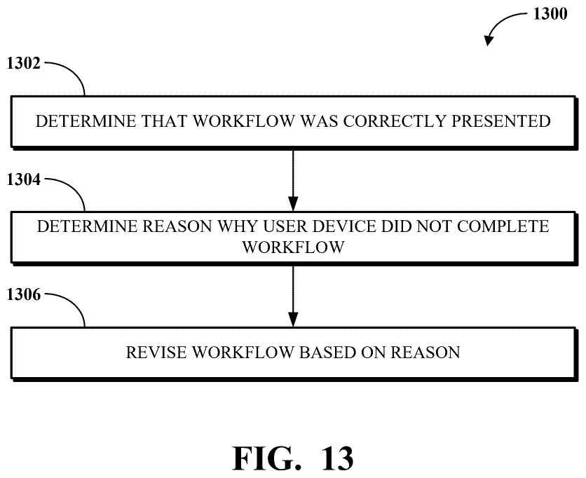

To further describe some implementations in greater detail, reference is next made to examples of techniques which may be performed by or using a system for intelligent agent escalation in a contact center. FIG. 12 is a flowchart of an example of a technique 1200 for intelligent agent escalation. FIG. 13 is a flowchart of an example of a technique 1300 for identifying a workflow revision. The techniques 1200 and 1300 can be executed using computing devices, such as the systems, hardware, and software described with respect to FIGS. 1-11. The techniques 1200 and 1300 can be performed, for example, by executing a machine-readable program or other computer-executable instructions, such as routines, instructions, programs, or other code. The steps, or operations, of the techniques 1200, 1300, or another technique, method, process, or algorithm described in connection with the implementations disclosed herein can be implemented directly in hardware, firmware, software executed by hardware, circuitry, or a combination thereof.

For simplicity of explanation, the techniques 1200 and 1300 are depicted and described herein as a series of steps or operations. However, the steps or operations of the techniques 1200 or 1300 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

FIG. 12 illustrates the technique 1200 for intelligent agent escalation. The technique 1200 may be performed by a contact center server (e.g., the contact center server 504).

At 1202, the contact center server obtains, during a contact center engagement, a response to a user prompt received from a user device (e.g., the user device 502). The response includes natural language data and a workflow. The natural language data may include text or speech transmitted to the user device. The response can be obtained from a virtual agent engine (e.g., the virtual agent engine 512) of the contact center server or from an initial agent device (e.g., the initial agent device 506) operated by a human agent. The workflow may include interactive elements such as knowledgebase articles or guided procedures.

At 1204, the contact center server determines, based on activity of the user device associated with the workflow, to connect the user device to an agent device (e.g., the supervisory agent device 508). The agent device is different from the device that generated the natural language data and the workflow (e.g., the initial agent device or the contact center server). Determining to connect the user device to the agent device can be based on at least one of a request from the user device or a determination, by the contact center server, that assistance from a live, human agent would be useful. In some cases, with appropriate permission from and notification to the user, the contact center server tracks the activity of the user device associated with the workflow to make this determination. The tracked activity may include, for example, whether the user accessed the workflow, whether the user fully or partially completed the workflow, and locations, in the workflow, where the user stopped or paused for at least a threshold time period. In some cases, if the agent device is not available, the contact center engagement may be terminated and information about the contact center engagement may be stored by the contact center server (e.g., in the task storage 516) for later processing by the agent device or another device. The later processing may include contacting the user of the user device to initiate another contact center engagement.

At 1206, the contact center server generates, using a transformer engine (e.g., the transformer engine 510), a summary of the contact center engagement. The summary comprises a summarization of the natural language data and a representation of the user's interaction with the workflow. In some implementations, the summarization of the natural language data is a natural language text summary, and the representation of the user's interaction with the workflow includes a graphical representation of the user's progress through the workflow. The graphical representation can be generated using the transformer engine and based on a specified format. The specified format may be stored in a memory subsystem coupled with the contact center server and may be associated with an organization (e.g., a business) operating the contact center to communicate with users of the organization's goods or services. For example, for a knowledgebase article, the specified format may include an image of a page including the knowledgebase article with locations to which the user did not scroll highlighted in a first color and locations where the user stopped or paused scrolling highlighted in a second color. More broadly stated, where the workflow includes a knowledgebase article, the representation of the user interaction may include indications of whether the user device opened the knowledgebase article, whether the user scrolled through the knowledgebase article, and positions where scrolling was paused.

Various techniques may be used for training the transformer engine. In some examples, the transformer engine can be trained by pretraining on a corpus of text during a pretraining phase and finetuned to generate summaries of contact center engagements based on recorded videos available on publicly accessible video hosting web services (e.g., as described in conjunction with FIG. 7).

At 1208, the contact center server transmits, in response to determining to connect the user device to the agent device, the summary for display at the agent device in conjunction with a request for the agent device to connect to the contact center engagement (e.g., as shown in FIG. 11). This allows the agent to quickly understand the context of the user's issue and the steps already taken in attempt to resolve the user's issue.

In some implementations, the contact center server determines, based on data associated with communication between the user device and the agent device, that the workflow was correctly presented based on the user prompt. The transformer engine can determine a reason why the user device did not complete the workflow prior to connection with the agent device and can revise the workflow based on this reason. An example of this is described in conjunction with FIG. 10, where the user failed to open a link to an article because the title of the article and the natural language response provided to the user included too much technical jargon. Based on the above, the article could be revised (e.g., manually or using artificial intelligence techniques) to reduce the technical jargon, making it more accessible to non-technical users.

The technique 1200 thus enables efficient transfer of contextual information from an automated systems to a human agent, or from one human agent to another, thereby improving the user's experience and reducing redundancy in the support process of the contact center.

FIG. 13 illustrates the technique 1300 for identifying a workflow for revision. The technique 1300 may be performed by a contact center server (e.g., the contact center server 504). The technique 1300 may be performed in conjunction with the technique 1200 and/or after the technique 1200.

At 1302, the contact center server determines that the workflow was correctly presented to the user device based on the user prompt. This determination involves analyzing data associated with the communication between the user device and the agent device to verify that the intended workflow was delivered accurately. The contact center server checks if the workflow steps, instructions, or resources were displayed properly and if there were no technical issues hindering the presentation.

At 1304, the contact center server determines, using the transformer engine, a reason why the user device did not complete the workflow prior to the connection with the agent device (e.g., the supervisory agent device 508). The transformer engine analyzes the tracked user activity with respect to the workflow, such as pauses, repeated actions, or abandonment points within the workflow. The transformer engine may process natural language data (or other data, e.g., non-natural language grunting sounds) from the user to understand sentiments or expressions of confusion, frustration, or other emotions that indicate obstacles in completing the workflow.

At 1306, the contact center server revises the workflow based on the identified reason. The transformer engine may generate modifications to the workflow to address the issues encountered by the user. For example, it might simplify certain steps, add clarifying information, or reorder tasks to improve user comprehension and completion rates. The revised workflow aims to enhance the overall user experience and efficiency of the contact center service. In some cases, the modifications made by the transformer engine may be transmitted to the agent device or an administrator device before publication.

As described above, in some implementations, the contact center server may track the activity of the user device associated with the workflow to gather more detailed insights into the areas of the workflow where the user might be having difficulties. This tracking may include monitoring time spent on each step, interactions with specific elements, and any error messages encountered. Such data enriches the analysis performed by the transformer engine, leading to more effective workflow revisions.

The technique 1300 enables continuous improvement of workflows by leveraging advanced machine learning models to understand user behavior and feedback. By systematically identifying and addressing the reasons why users do not complete workflows, the contact center service can generate more intuitive and user-friendly support solutions, ultimately enhancing customer satisfaction and reducing the need for agent intervention.

In an example use case of the disclosed technology, when a customer reaches out to a company's support center and interacts with an automated virtual assistant, the system monitors the conversation and the customer's engagement with any provided self-service workflows or resources. If the customer still requires help and requests to speak with a live agent, the technology employs an AI-powered transformer engine to create a concise summary of the customer's issue and their prior interactions. This summary is then delivered to the support agent before they connect with the customer, enabling the agent to quickly understand the context and history of the problem. As a result, the agent can offer more efficient and personalized assistance, enhancing customer satisfaction and reducing resolution times.

Some implementations are described below as numbered examples (Example 1, 2, 3, etc.). These examples are provided as examples only and do not limit the other implementations disclosed herein.

Example 1 is a method, comprising: obtaining, by a contact center server during a contact center engagement, a response to a user prompt received from a user device, the response comprising natural language data and a workflow; determining, by the contact center server and based on activity of the user device associated with the workflow, to connect the user device to an agent device; generating, using a transformer engine of the contact center server, a summary of the contact center engagement, the summary comprising a summarization of the natural language data and a representation of user interaction with the workflow; and transmitting, by the contact center server in response to determining to connect the user device to the agent device, the summary for display at the agent device in conjunction with a request for the agent device to connect to the contact center engagement.

In Example 2, the subject matter of Example 1 includes, wherein the agent device is different from a device that generated the response.

In Example 3, the subject matter of Examples 1-2 includes, tracking, by the contact center server, the activity of the user device associated with the workflow.

In Example 4, the subject matter of Examples 1-3 includes, wherein obtaining the response comprises: obtaining, by the contact center server, the response from an initial agent device different from the agent device.

In Example 5, the subject matter of Examples 1-4 includes, wherein obtaining the response comprises: obtaining the response from a virtual agent engine of the contact center server.

In Example 6, the subject matter of Examples 1-5 includes, wherein the natural language data comprises at least one of text or speech.

In Example 7, the subject matter of Examples 1-6 includes, wherein determining to connect the user device to the agent device comprises: determining, by the contact center server, to connect the user device to the agent device based on at least one of a request from the user device or a determination, by the contact center server, to connect to the agent device.

In Example 8, the subject matter of Examples 1-7 includes, wherein the summarization of the natural language data comprises a natural language text summary, wherein the representation of the user interaction with the workflow comprises a graphical representation of user progress through the workflow, the method further comprising: generating, by the contact center server, the graphical representation using the transformer engine and based on a specified format for the graphical representation.

In Example 9, the subject matter of Examples 1-8 includes, wherein the workflow comprises a knowledgebase article, wherein the representation of the user interaction with the workflow comprises an indication of whether the user device viewed the knowledgebase article.

In Example 10, the subject matter of Examples 1-9 includes, wherein the workflow comprises a knowledgebase article, wherein the representation of the user interaction with the workflow comprises an indication of scrolling through the knowledgebase article and an indication of positions in the knowledgebase article where the scrolling was paused.

In Example 11, the subject matter of Examples 1-10 includes, training the transformer engine by: pretraining the transformer engine on a corpus of at least one of text, audio, or video in a pretraining phase; and finetuning the transformer engine to generate summaries of contact center engagements based on recorded videos of contact center engagements available on video hosting web services.

In Example 12, the subject matter of Examples 1-11 includes, determining, by the contact center server and based on data associated with communication between the user device and the agent device, that the workflow was correctly presented in response to the user prompt; determining, using the transformer engine, a reason why the user device did not complete the workflow prior to connection of the agent device; and revising, by the transformer engine, the workflow based on the reason.

In Example 13, the subject matter of Examples 1-12 includes, wherein the contact center server comprises a server farm including multiple machines.

Example 14 is a non-transitory computer readable medium storing instructions operable to cause one or more processors to perform operations comprising: obtaining, by a contact center server during a contact center engagement, a response to a user prompt received from a user device, the response comprising natural language data and a workflow; determining, by the contact center server and based on activity of the user device associated with the workflow, to connect the user device to an agent device; generating, using a transformer engine of the contact center server, a summary of the contact center engagement, the summary comprising a summarization of the natural language data and a representation of user interaction with the workflow; and transmitting, by the contact center server in response to determining to connect the user device to the agent device, the summary for display at the agent device in conjunction with a request for the agent device to connect to the contact center engagement.

In Example 15, the subject matter of Example 14 includes, the operations further comprising: tracking, by the contact center server, the activity of the user device during the contact center engagement.

In Example 16, the subject matter of Examples 14-15 includes, wherein obtaining the response comprises: obtaining, by the contact center server, the response from at least one of an initial agent device different from the agent device or a virtual agent engine of the contact center server.

In Example 17, the subject matter of Examples 14-16 includes, wherein the natural language data comprises at least one of natural language text or natural language speech.

In Example 18, the subject matter of Examples 14-17 includes, wherein determining to connect the user device to the agent device comprises: determining, by the contact center server, to connect the user device to the agent device based on a request from the user device.

Example 19 is a system, comprising: a memory subsystem storing instructions; and processing circuitry configured to execute the instructions to: obtain, by a contact center server during a contact center engagement, a response to a user prompt received from a user device, the response comprising natural language data and a workflow; determine, by the contact center server and based on activity of the user device associated with the workflow, to connect the user device to an agent device; generate, using a transformer engine of the contact center server, a summary of the contact center engagement, the summary comprising a summarization of the natural language data and a representation of user interaction with the workflow; and transmit, by the contact center server in response to determining to connect the user device to the agent device, the summary for display at the agent device in conjunction with a request for the agent device to connect to the contact center engagement.

In Example 20, the subject matter of Example 19 includes, wherein the workflow comprises an article, wherein the representation of the user interaction with the workflow comprises an indication of positions in the article where scrolling through the article was paused.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

As used herein, unless explicitly stated otherwise, any term specified in the singular may include its plural version. For example, “a computer that stores data and runs software,” may include a single computer that stores data and runs software or two computers - a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

As used herein, the term “and/or” encompasses its plain and ordinary meaning and may refer to either an intersection or a union of sets of data. In a first example, the phrase “A and/or B” encompasses the intersection of A and B. In a second example, the phrase “A and/or B” encompasses the union of A and B.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
obtaining, by a contact center server during a contact center engagement, a response to a user prompt received from a user device, the response comprising natural language data and a workflow;
determining, by the contact center server and based on activity of the user device associated with the workflow, to connect the user device to an agent device;
generating, using a transformer engine of the contact center server, a summary of the contact center engagement, the summary comprising a summarization of the natural language data and a representation of user interaction with the workflow; and
transmitting, by the contact center server in response to determining to connect the user device to the agent device, the summary for display at the agent device in conjunction with a request for the agent device to connect to the contact center engagement.

2. The method of claim 1, wherein the agent device is different from a device that generated the response.

3. The method of claim 1, further comprising:
tracking, by the contact center server, the activity of the user device associated with the workflow.

4. The method of claim 1, wherein obtaining the response comprises:
obtaining, by the contact center server, the response from an initial agent device different from the agent device.

5. The method of claim 1, wherein obtaining the response comprises:
obtaining the response from a virtual agent engine of the contact center server.

6. The method of claim 1, wherein the natural language data comprises at least one of text or speech.

7. The method of claim 1, wherein determining to connect the user device to the agent device comprises:
determining, by the contact center server, to connect the user device to the agent device based on at least one of a request from the user device or a determination, by the contact center server, to connect to the agent device.

8. The method of claim 1, wherein the summarization of the natural language data comprises a natural language text summary, wherein the representation of the user interaction with the workflow comprises a graphical representation of user progress through the workflow, the method further comprising:
generating, by the contact center server, the graphical representation using the transformer engine and based on a specified format for the graphical representation.

9. The method of claim 1, wherein the workflow comprises a knowledgebase article, wherein the representation of the user interaction with the workflow comprises an indication of whether the user device viewed the knowledgebase article.

10. The method of claim 1, wherein the workflow comprises a knowledgebase article, wherein the representation of the user interaction with the workflow comprises an indication of scrolling through the knowledgebase article and an indication of positions in the knowledgebase article where the scrolling was paused.

11. The method of claim 1, further comprising training the transformer engine by:
pretraining the transformer engine on a corpus of at least one of text, audio, or video in a pretraining phase; and
finetuning the transformer engine to generate summaries of contact center engagements based on recorded videos of contact center engagements available on video hosting web services.

12. The method of claim 1, further comprising:
determining, by the contact center server and based on data associated with communication between the user device and the agent device, that the workflow was correctly presented in response to the user prompt;
determining, using the transformer engine, a reason why the user device did not complete the workflow prior to connection of the agent device; and
revising, by the transformer engine, the workflow based on the reason.

13. The method of claim 1, wherein the contact center server comprises a server farm including multiple machines.

14. A non-transitory computer readable medium storing instructions operable to cause one or more processors to perform operations comprising:
obtaining, by a contact center server during a contact center engagement, a response to a user prompt received from a user device, the response comprising natural language data and a workflow;
determining, by the contact center server and based on activity of the user device associated with the workflow, to connect the user device to an agent device;
generating, using a transformer engine of the contact center server, a summary of the contact center engagement, the summary comprising a summarization of the natural language data and a representation of user interaction with the workflow; and
transmitting, by the contact center server in response to determining to connect the user device to the agent device, the summary for display at the agent device in conjunction with a request for the agent device to connect to the contact center engagement.

15. The non-transitory computer readable medium of claim 14, the operations further comprising:
tracking, by the contact center server, the activity of the user device during the contact center engagement.

16. The non-transitory computer readable medium of claim 14, wherein obtaining the response comprises:
obtaining, by the contact center server, the response from at least one of an initial agent device different from the agent device or a virtual agent engine of the contact center server.

17. The non-transitory computer readable medium of claim 14, wherein the natural language data comprises at least one of natural language text or natural language speech.

18. The non-transitory computer readable medium of claim 14, wherein determining to connect the user device to the agent device comprises:
determining, by the contact center server, to connect the user device to the agent device based on a request from the user device.

19. A system, comprising:
a memory subsystem storing instructions; and
processing circuitry configured to execute the instructions to:
obtain, by a contact center server during a contact center engagement, a response to a user prompt received from a user device, the response comprising natural language data and a workflow;
determine, by the contact center server and based on activity of the user device associated with the workflow, to connect the user device to an agent device;
generate, using a transformer engine of the contact center server, a summary of the contact center engagement, the summary comprising a summarization of the natural language data and a representation of user interaction with the workflow; and
transmit, by the contact center server in response to determining to connect the user device to the agent device, the summary for display at the agent device in conjunction with a request for the agent device to connect to the contact center engagement.

20. The system of claim 19, wherein the workflow comprises an article, wherein the representation of the user interaction with the workflow comprises an indication of positions in the article where scrolling through the article was paused.
